(19) United States
(12) Patent Application Publication
(10) Pub. No.: US 2010/0051394 A1
(43) Pub. Date: Mar. 4, 2010

(54) Bicycle brake system for preventing a front wheel from being braked alone

(76) Inventor: Szu-Fang Tsai, Changhua (TW)

Correspondence Address: SAM CHEN, 7F-1, 293, ROOSEVELT ROAD, SEC 3, TAIPEI, TW

(21) Appl. No.: 12/198,130

(22) Filed: Aug. 26, 2008

(51) Int. Cl. F16D 55/228

(52) U.S. Cl. 188/72.5

(57) ABSTRACT

In on embodiment, a brake system of bicycle including left and right brake levers, front and rear wheels, a front disc brake, and a rear disc brake having a first unit and an independent second unit, the brake system includes a hydraulic line interconnected the right brake lever and the first unit; and a Y-shaped hydraulic line having a first branch connected to the left brake lever, a second branch connected to the front disc brake, and a third branch connected to the second unit. Pressing the right brake lever will actuate the first unit via the hydraulic line to brake the rear wheel, and pressing the left brake lever will actuate the front disc brake via the first and second branches to brake the front wheel and actuate the second unit via the first and third branches to brake the rear wheel respectively.

### BACKGROUND OF THE INVENTION

1. Field of Invention

The invention relates to bicycle brakes and more particularly to a disc type bicycle brake system for preventing a front wheel from being braked alone.

2. Description of Related Art

Disc brake is a conventional type of bicycle brake. Disc brakes are common on off-road bicycles, recumbent bicycles, etc.

For example, in response to pressing a left brake lever against a left grip force is transmitted to two front friction pads via a first hydraulic line. Likewise, in response to pressing a right brake lever against a right grip force is transmitted to two rear friction pads via a second hydraulic line. However, in some countries the above brake arrangement may be reverse. That is, front friction pads are actuated by pressing the right brake lever and rear friction pads are actuated by pressing the left brake lever.

It is understood that a safe braking order involves braking a rear wheel prior to braking a front wheel. However, it is very possible that a rider may brake the front wheel first due to nervousness in case of emergency. As a result, the sudden brake of the front wheel unbalances the bicycle and even causes the rider to fall from the bicycle. This is very dangerous especially if the riding speed is high. Thus, a need for improvement exists.

### SUMMARY OF THE INVENTION

It is therefore one object of the invention to provide a disc type bicycle brake system for preventing a front wheel from being braked alone.

The above and other objects, features and advantages of the invention will become apparent from the following detailed description taken with the accompanying drawings.

### BRIEF DESCRIPTION OF THE DRAWINGS

FIG. 1 is a perspective view of a schematic bicycle incorporating a preferred embodiment of brake system according to the invention;

FIG. 2 schematically shows the brake system; and

FIGS. 3 and 4 schematically show a portion of the brake system mounted to the rear hub.

### DETAILED DESCRIPTION OF THE INVENTION

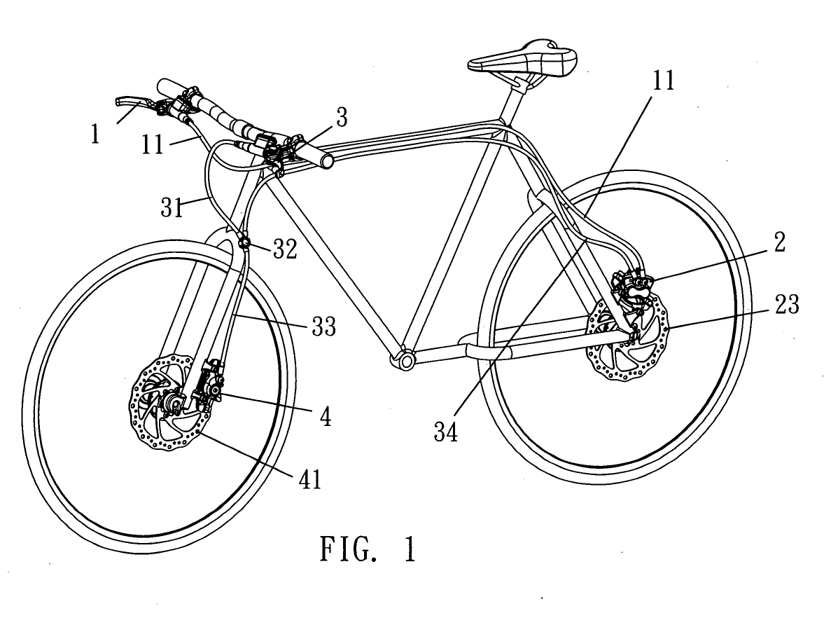

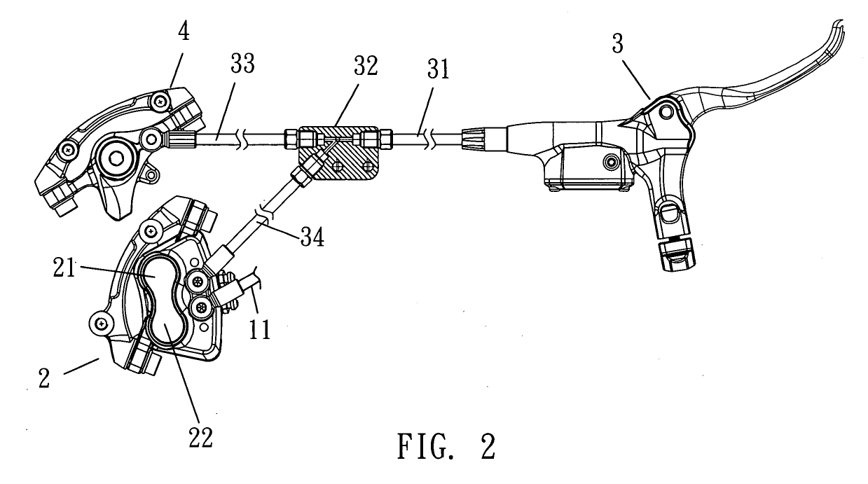

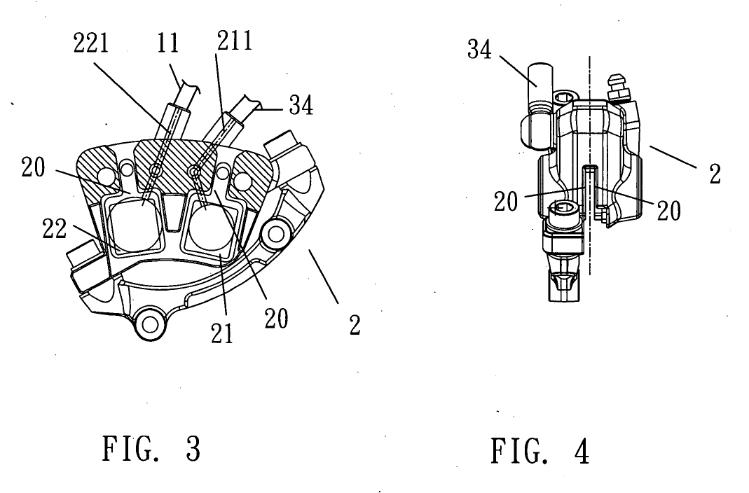

Referring to FIGS. 1 to 4, a bicycle incorporating a brake system in accordance with a preferred embodiment of the invention is shown. The brake system comprises the following components as discussed in detail below.

A right brake lever 1 is operatively connected to a rear disc brake 2 via a first hydraulic line 11. A left brake lever 3 is operatively connected to an enlarged distribution member 32 via a second hydraulic line 31. The distribution member 32 in turn is branched into a third hydraulic line 33 and a fourth hydraulic line 34. The third hydraulic line 33 is operatively connected to a front disc brake 4 and the fourth hydraulic line 34 is operatively connected to the rear disc brake 2 respectively.

The rear disc brake 2 has a second hydraulic caliper 22 operatively connected to the right brake lever 1 and a first hydraulic caliper 21 operatively connected to the left brake lever 3. The left brake lever 3 is adapted to simultaneously actuate both the front disc brake 4 and the rear disc brake 2 by pressing against a grip (not numbered). An in turn, front and rear discs 41, 23 are actuated to cause the front and rear disc brakes 4, 2 to brake the front and rear wheels (not numbered) respectively. This arrangement can prevent a rider from braking the front wheel first in case of emergency.

The rear disc brake 2 further comprises a first brake line 211 in fluid communication between the fourth hydraulic line 34 and the first hydraulic caliper 21, and a second brake line 221 in fluid communication between the first hydraulic line 11 and the second hydraulic caliper 22. The first brake 21 is adapted to actuate a rear disc 23 via an associated pair of brake linings 20 and the second brake 22 is adapted to actuate the rear disc 23 via another associated pair of brake linings 20 respectively. That is, in response to pressing the right brake lever 1 against the right grip force is transmitted to the rear disc 23 for braking the rear wheel via the first hydraulic line 11, the second brake line 221, the second hydraulic caliper 22, and the brake linings 20. In response to pressing the left brake lever 3 against the left grip a portion of force is transmitted to the rear disc 23 for braking the rear wheel via the second hydraulic line 31, the distribution member 32, the fourth hydraulic line 34, the first brake line 211, the first hydraulic caliper 21, and the brake linings 20; and the remaining portion of force is simultaneously transmitted to the front disc 41 for braking the front wheel via the second hydraulic line 31, the distribution member 32, the third hydraulic line 33, a third brake line (not numbered), a third hydraulic caliper (not numbered), and another associated brake lining (not numbered).

In short, pressing the right brake lever will actuate the rear disc brake and pressing the left brake lever will actuate the front and rear disc brakes both. In either case, the front disc brake will not be actuated alone. Therefore, the danger of braking the front wheel without or before braking the rear wheel is eliminated.

Note that it is possible of configuring the invention as pressing the left brake lever will actuate the rear disc brake and pressing the right brake lever will actuate both the front and rear disc brakes in other embodiments.

While the invention herein disclosed has been described by means of specific embodiments, numerous modifications and variations could be made thereto by those skilled in the art without departing from the scope and spirit of the invention set forth in the claims.

What is claimed is:

1. A brake system mounted to a bicycle including a left brake lever, a right brake lever, a front wheel, a rear wheel, a front disc brake, and a rear disc brake having a first unit and a second unit being independent from the first unit, the brake system comprising:
a first hydraulic line interconnected the right brake lever and the first unit of the rear disc brake; and
a Y-shaped hydraulic line having a first branch connected to the left brake lever, a second branch connected to the front disc brake, and a third branch connected to the second unit of the rear disc brake,
whereby pressing the right brake lever will actuate the first unit of the rear disc brake via the first hydraulic line to brake the rear wheel, and pressing the left brake lever will actuate the front disc brake via the first and the second branches to brake the front wheel and actuate the second unit of the rear disc brake via the first and the third branches to brake the rear wheel respectively.

2. The brake system of claim 1, wherein each of the first and the second units of the rear disc brake comprises a brake line, a hydraulic caliper, and a pair of linings.

3. A brake system mounted to a bicycle including a left brake lever, a right brake lever, a front wheel, a rear wheel, a front disc brake, and a rear disc brake having a first unit and a second unit being independent from the first unit, the brake system comprising:
a first hydraulic line interconnected the left brake lever and the first unit of the rear disc brake; and
a Y-shaped hydraulic line having a first branch connected to the right brake lever, a second branch connected to the front disc brake, and a third branch connected to the second unit of the rear disc brake,
whereby pressing the left brake lever will actuate the first unit of the rear disc brake via the first hydraulic line to brake the rear wheel, and pressing the right brake lever will actuate the front disc brake via the first and the second branches to brake the front wheel and actuate the second unit of the rear disc brake via the first and the third branches to brake the rear wheel respectively.

4. The brake system of claim 3, wherein each of the first and the second units of the rear disc brake comprises a brake line, a hydraulic caliper, and a pair of linings.
